(19) United States
(12) Patent Application Publication
(10) Pub. No.: US 2006/0226660 A1
(43) Pub. Date: Oct. 12, 2006

(54) Lock with a status indicator

(76) Inventor: Ting-Pin Wu, Jhongli City (TW)

Correspondence Address: COOPER & DUNHAM, LLP, 1185 AVENUE OF THE AMERICAS, NEW YORK, NY, 10036, US

(21) Appl. No.: 11/103,336

(22) Filed: Apr. 11, 2005

(51) Int. Cl. E05C 1/04

(52) U.S. Cl. 292/145

(57) ABSTRACT

A lock with a status indicator has a seat, a latch seat, a latch and an indicator. The seat is mounted inside a public toilet stall door. The latch seat is mounted on a doorframe jamb and corresponds to and aligns with the seat. The latch is mounted in the seat and has a distal end that selectively engages the latch seat to lock the door. The indicator is mounted on the outside of the door. When the toilet stall door is locked, the indicator turns on to indicate that the toilet stall is occupied. With a clear and visible indication that the toilet stall door is locked, people will not push the door so the door will not be damaged.

### BACKGROUND OF THE INVENTION

1. Field of the Invention

The present invention relates to a lock, and more particularly to a lock with a status indicator that indicates when the lock is locked.

2. Description of Related Art

Most public facilities, such as schools, movie theaters, subway stations, amusement parks and the like have public restrooms. Most toilets have locks on the doors to ensure privacy.

However, lock status indicators on toilet stall doors are often difficult to see, and people must push the doors to determine whether or not the stall door is unlocked. In the urgency of locating a vacant toilet stall, people often push the stall doors with excessive force. The excessive force eventually damages the stall doors or the locks so the stall doors cannot be locked.

To overcome the shortcomings, the present invention provides a lock with a status indicator to obviate or mitigate the aforementioned problems.

### SUMMARY OF THE INVENTION

The primary objective of the present invention is to provide a lock with a status indicator that clearly indicates whether a toilet stall is locked or unlocked.

The lock with a status indicator has a seat, a latch seat, a latch and an indicator. The seat is mounted inside a public toilet stall door. The latch seat is mounted on a toilet stall doorframe jamb and corresponds to and aligns with the seat. The latch is mounted in the seat and has a distal end that selectively engages the latch seat to lock the door. The indicator is mounted on the outside of the toilet stall door. When the toilet stall door is locked, the indicator turns on to indicate that the toilet stall is occupied. With a clear and visible indication that the toilet stall door is locked, people will not push the door so the door will not be damaged.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lock with a status indicator in accordance with the present invention from the inside a toilet stall;

FIG. 2 is a perspective view of the lock with a status indicator in FIG. 1;

FIG. 3 is a top view in partial section of the lock with a status indicator in FIG. 1;

FIG. 4 is a side view in partial section of the lock with a status indicator in FIG. 1;

FIG. 5 is an operational perspective view of the lock with a status indicator in FIG. 1 when the lock is locked;

FIG. 6 is an operational perspective view of the lock with a status indicator in FIG. 1 when the status indicator is activated;

FIG. 7 is an operational top view in partial section of the lock with a status indicator in FIG. 1 when the status indicator is activated;

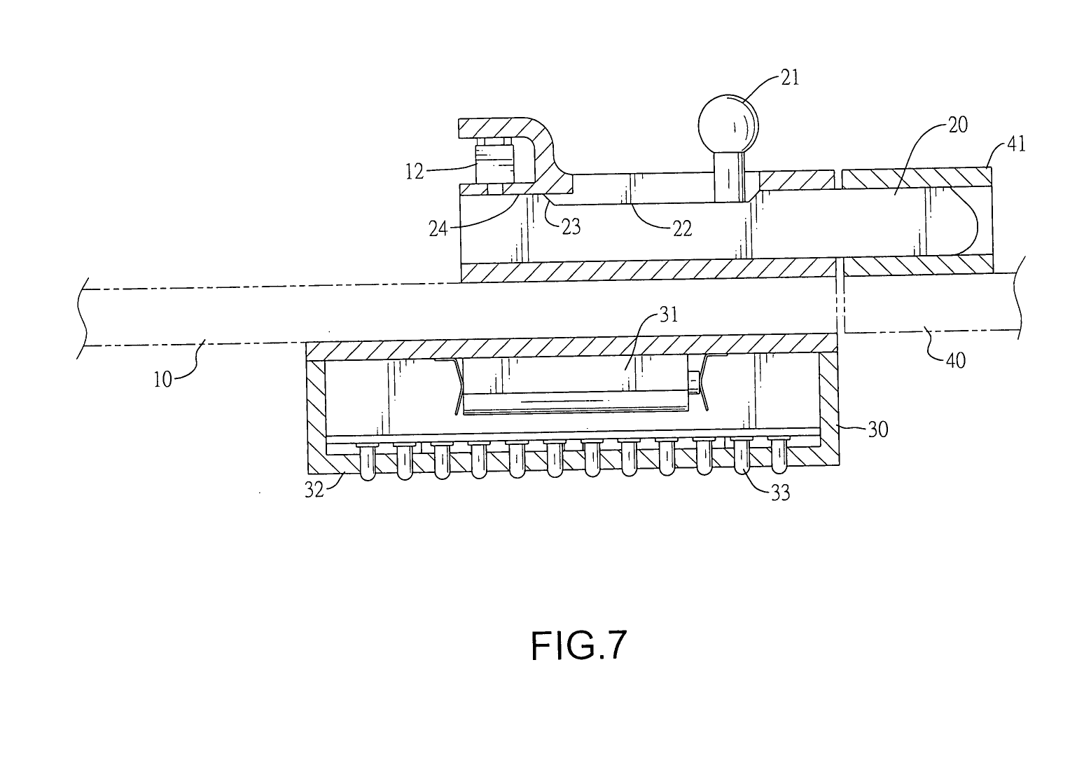

FIG. 8 is an operational perspective view of a second embodiment of the lock with a status indicator in accordance with the present invention when the status indicator is activated;

FIG. 9 is a top view in partial section of a third embodiment of the lock with a status indicator in accordance with the present invention when the lock is unlocked;

FIG. 10 is a top view in partial section of the lock with a status indicator in FIG. 9 when the lock is locked; and

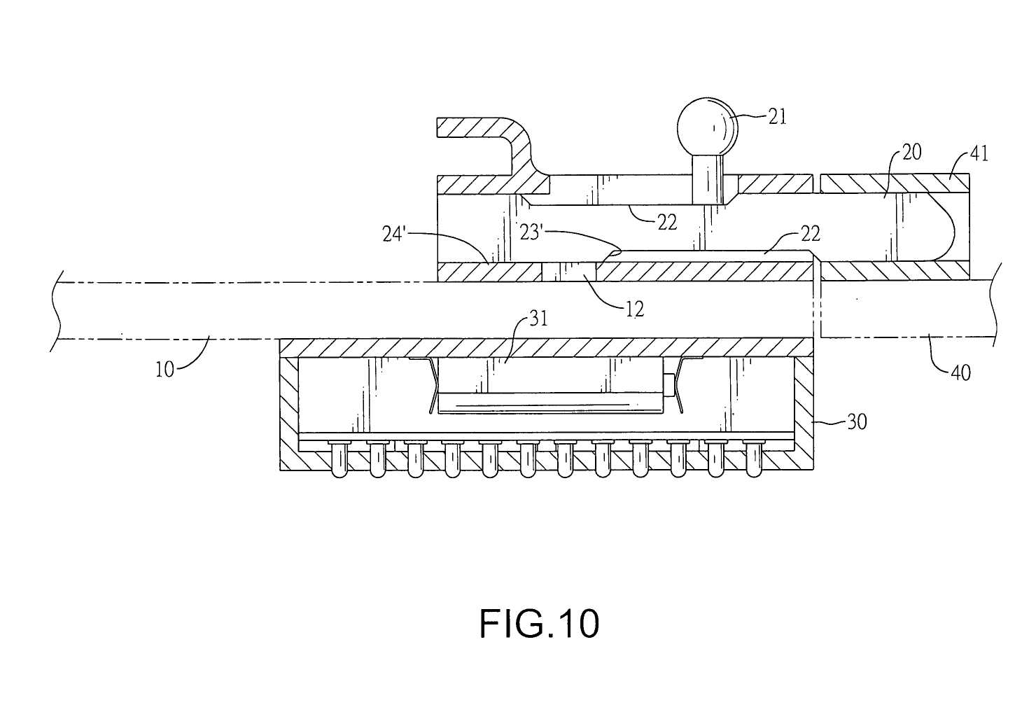

FIG. 11 is a top view in partial section of a fourth embodiment of the lock with a status indicator in accordance with the present invention when the lock is unlocked.

### DETAILED DESCRIPTION OF THE PREFERRED EMBODIMENT

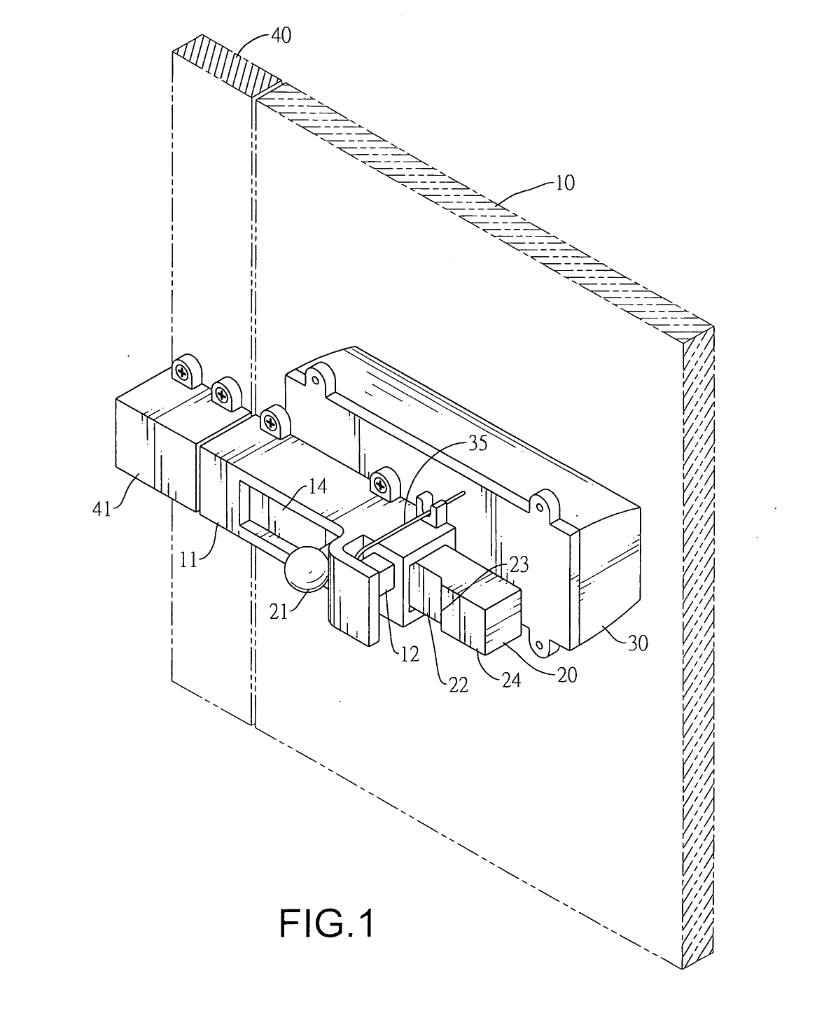

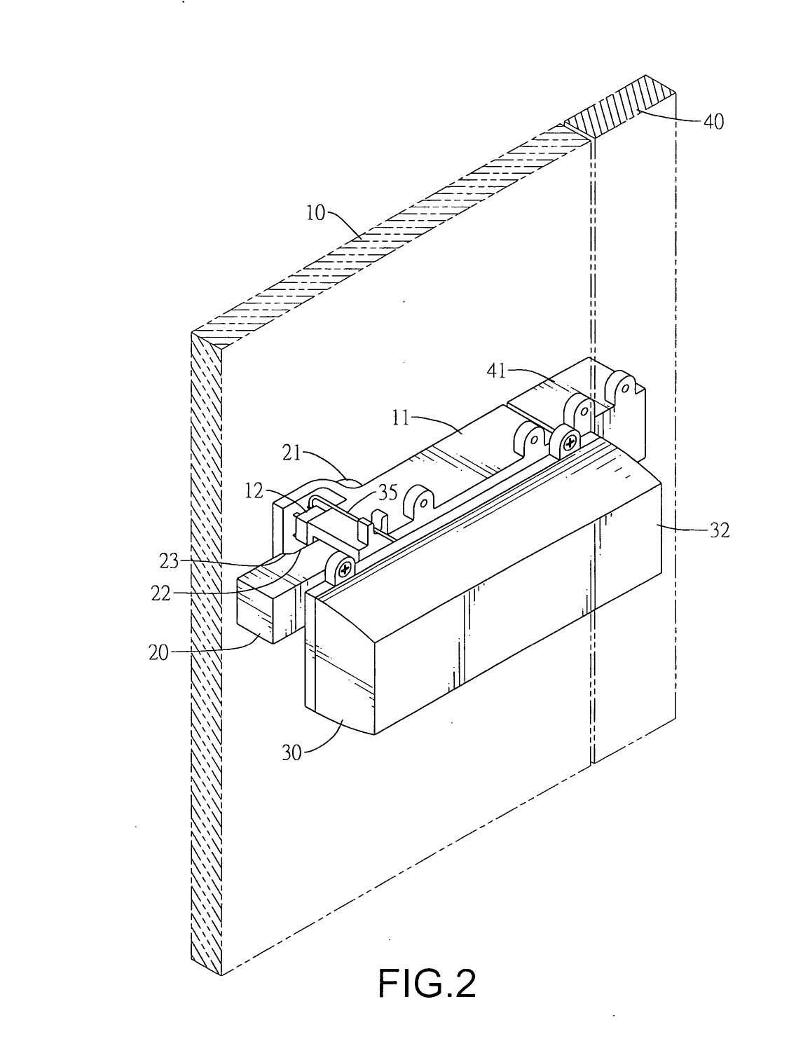

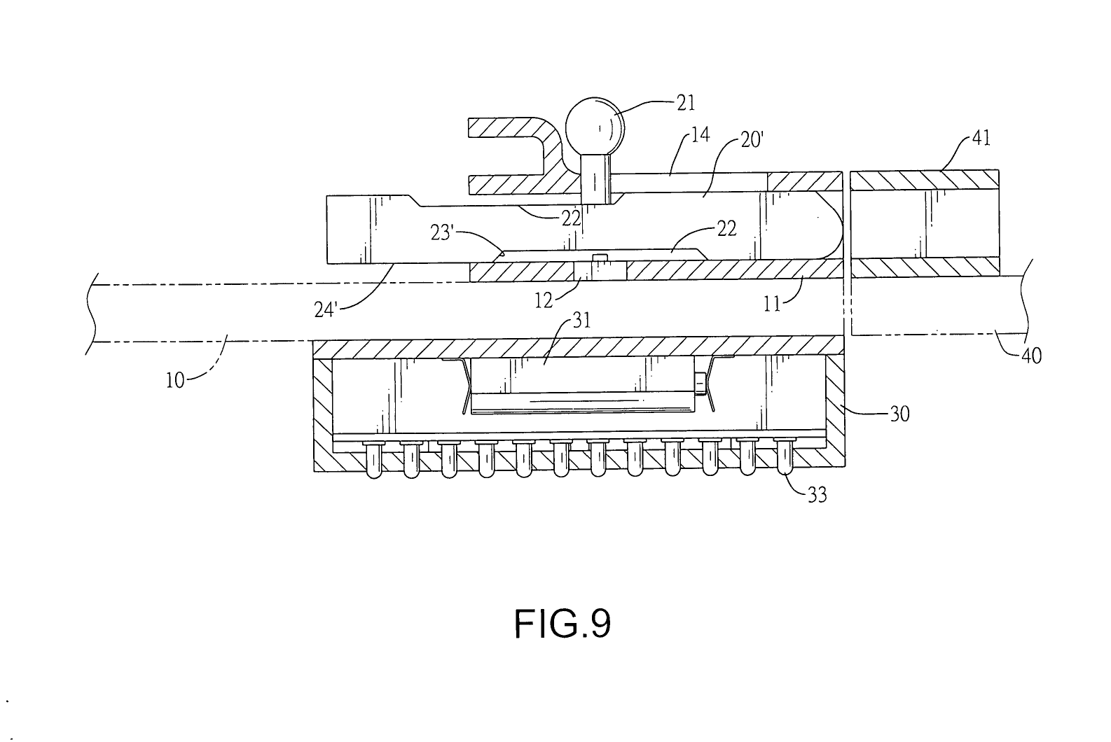

With reference to FIGS. 1, 2, 3 and 9, a lock with a status indicator in accordance with the present invention comprises a seat (11), an optional latch seat (41), a latch (20, 20′), a switch (12) and a indicator (30).

The seat (11) is hollow and mounted on an inside surface of a door (10) and has an inner end, an outer end, an inner opening, an outer opening, an outer side, an inner side, an optional activation hole (13), an optional mounting hole and a guide slot (14). The inner opening is formed in the inner end, and the outer opening is formed in the outer end. The activation hole (13) is formed through the outer side near the inner end of the seat (10). The mounting hole is formed through the inner side between the inner and outer ends. The guide slot (14) is formed longitudinally through the outer side of the seat (10) between the inner and outer ends.

The latch seat (41) is hollow, is mounted on a doorframe jamb (40) and has an inner opening. The inner opening of the latch seat (41) corresponds to the outer opening in the seat (11).

The latch (20, 20′) is mounted slidably inside the seat (10) and has an outer end, an inner end, an outer surface, an inner surface, a longitudinal recess (22), an optional longitudinal recess (22), a contact surface (24, 24′), an optional inclined surface (23, 23′) and a handle (21). The outer end of the latch (20, 20′) selectively extends into the latch seat (41) through the outer opening in the latch seat (41) to lock the door (10) to the doorframe jamb (40). The longitudinal recess (22) is formed in the outer surface of the latch (20, 20′).

In a first embodiment of the lock with a status indicator in accordance with the present invention, the longitudinal recess (22) is formed in the outer surface of the latch (20), and the outer surface near the inner end of the latch (20) is a contact surface (24). The inclined surface (23) is formed in the outer surface between the longitudinal recess (22) and the contact surface (24) of the latch (20).

In a third embodiment of the lock with a status indicator in accordance with the present invention, another longitudinal recess (22) is formed in the inner surface of the latch (20′), and the inner surface near the inner end of the latch (20) is a contact surface (24′). The inclined surface (23′) is formed in the inner surface between the longitudinal recess (22) and the contact surface (24′) of the latch (20′).

The handle (21) has a proximal end and a distal end. The proximal end of the handle (21) is attached to the outer surface of the latch (20) in the longitudinal recess (22) in the outer surface of the latch (20). The distal end of the handle (21) extends out of the guide slot (14) in the seat (11).

The switch (12) is mounted on the seat (11), is activated by the latch (20, 20′) and has a trigger. The trigger extends into one of the longitudinal recesses (22) and is depressed selectively by the inclined surface (23, 23′) and the contact surface (24, 24′) to activate the switch (12) when the outer end of the latch (20, 20′) slides into the latch seat (41). The trigger may be a pin or a lever.

In the first embodiment of the lock with a status indicator, the switch (12) is mounted on the outer surface of the seat (11) near the inner end of the seat (11), and the trigger extends through the activation hole (13) in the seat (11) into the longitudinal recess (22) in the outer surface of the latch (20).

In the third embodiment of the lock with a status indicator, the switch (12) is mounted in the mounting hole in the inner surface of the seat (11), and the trigger extends into the longitudinal recess (22) in the inner surface of the latch (20).

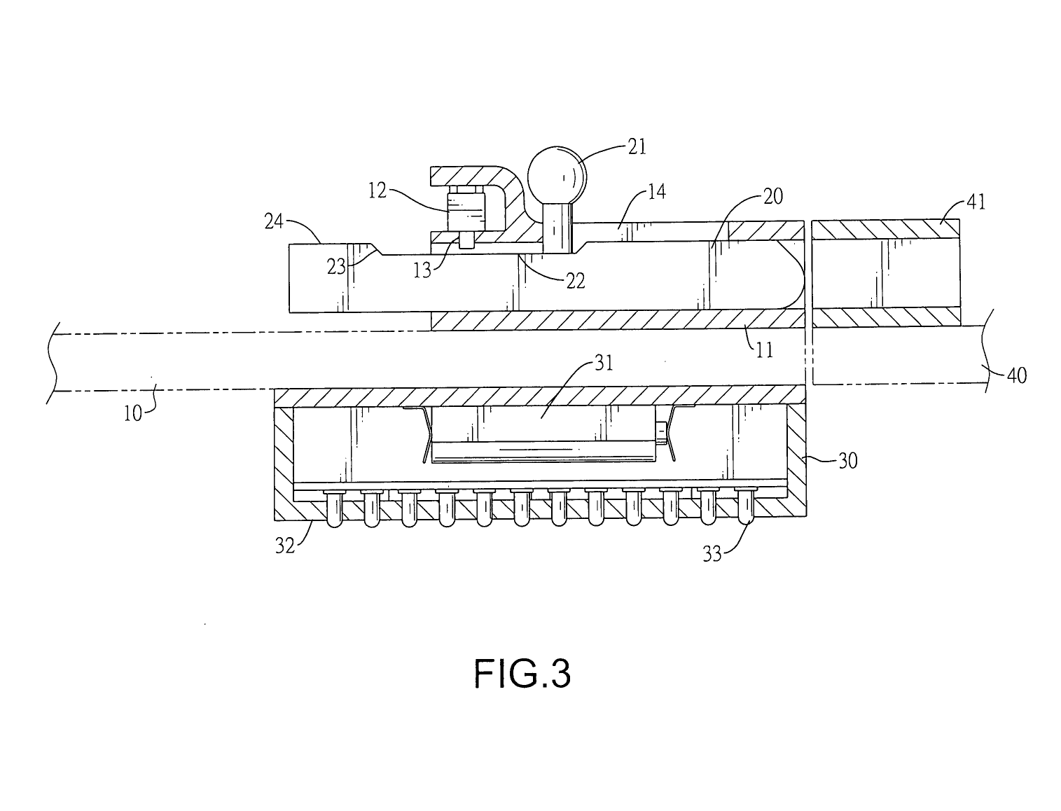

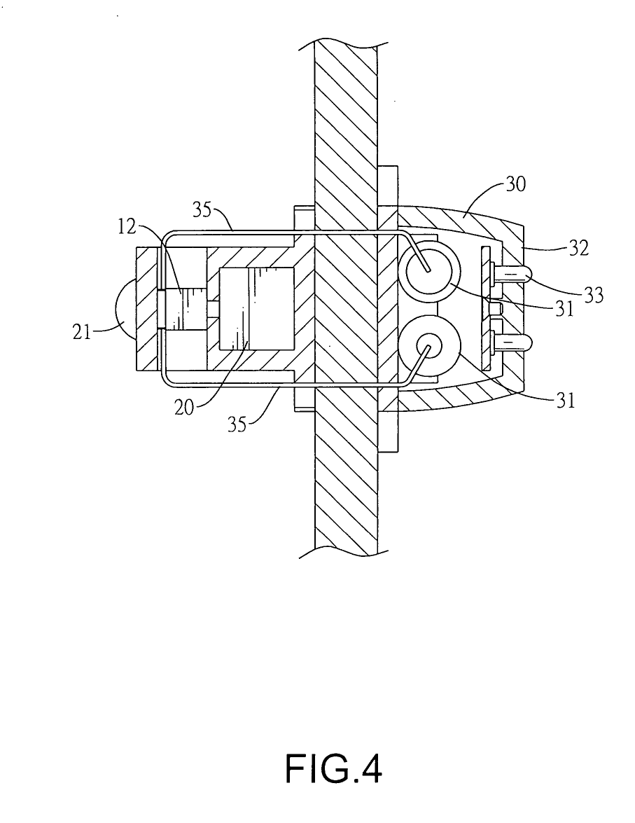

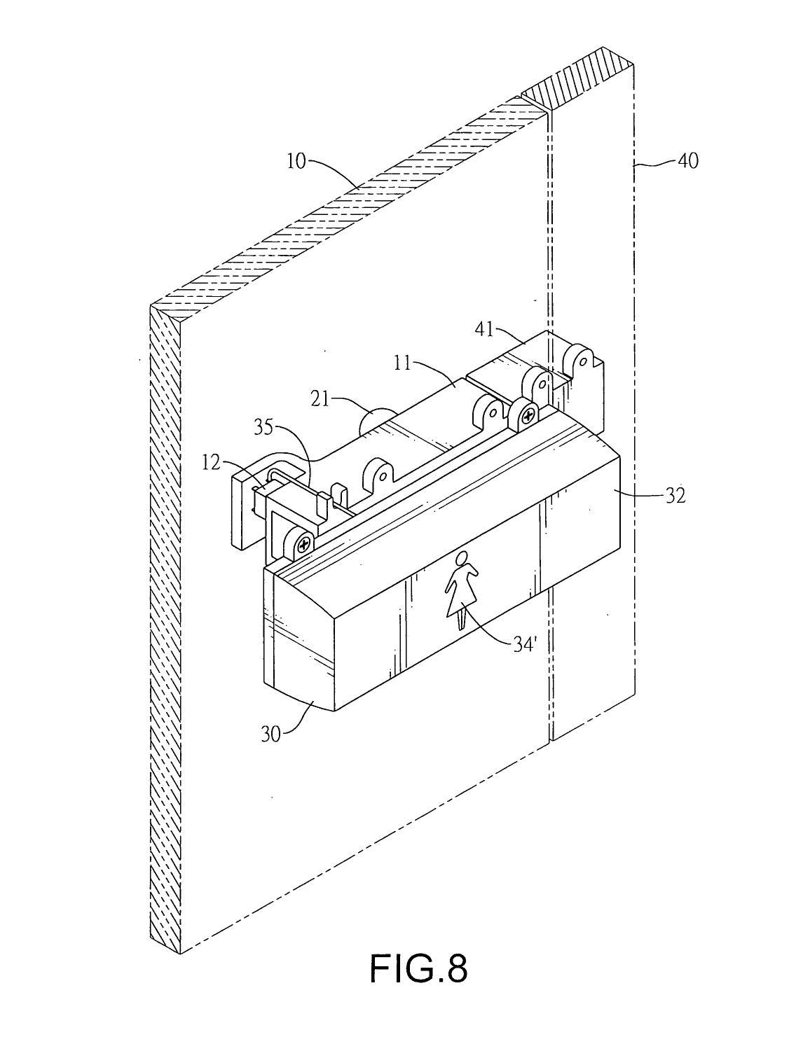

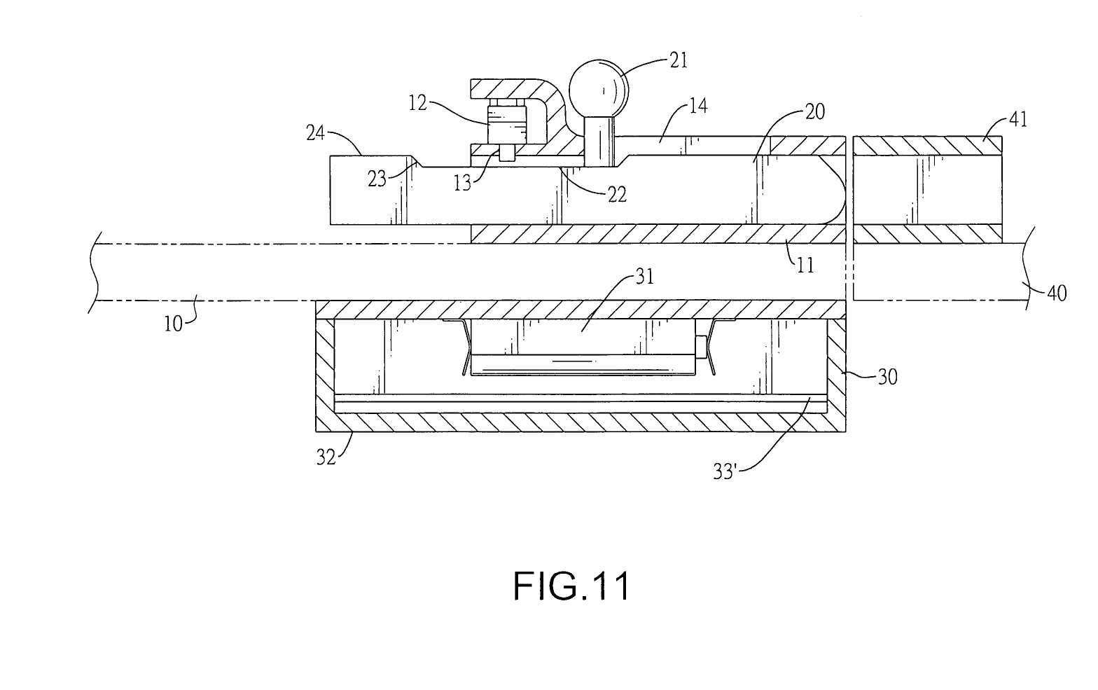

With further reference to FIGS. 3, 4, 6, 8 and 11, the indicator (30) is mounted on an outside surface of a door (10) and has an outside surface, at least one battery (31), a message panel (32), an illuminating device (33, 33′) and multiple electrical leads (35). The battery (31) is mounted in the indicator (30). The message panel (32) is mounted on the outside surface of the indicator (30) and has a message (34, 34′) on the message panel (32). The illuminating device (33, 33′) is mounted on the message panel (32).

In the first embodiment of the lock with a status indicator, the illuminating device (33) is multiple light-emitting diodes. The message (34) can be a word such as “occupied.”

In a second embodiment of the lock with a status indicator in accordance with the present invention, the message (34′) can be figures.

In a fourth embodiment of the lock with a status indicator in accordance with the present invention, the illuminating device (33′) is a luminescent card.

The electrical leads (35) are connected to the switch (12), the at least one battery (31) and the illuminating device (33, 33′) to control the illuminating device (33, 33′).

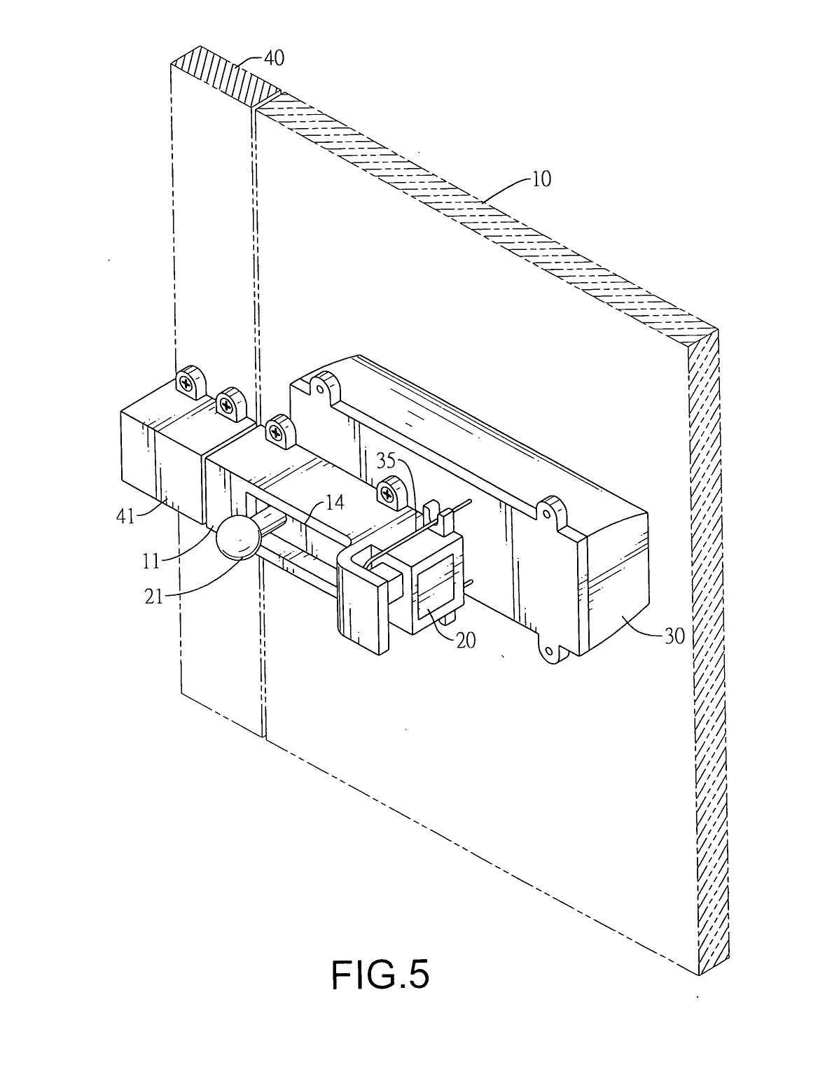

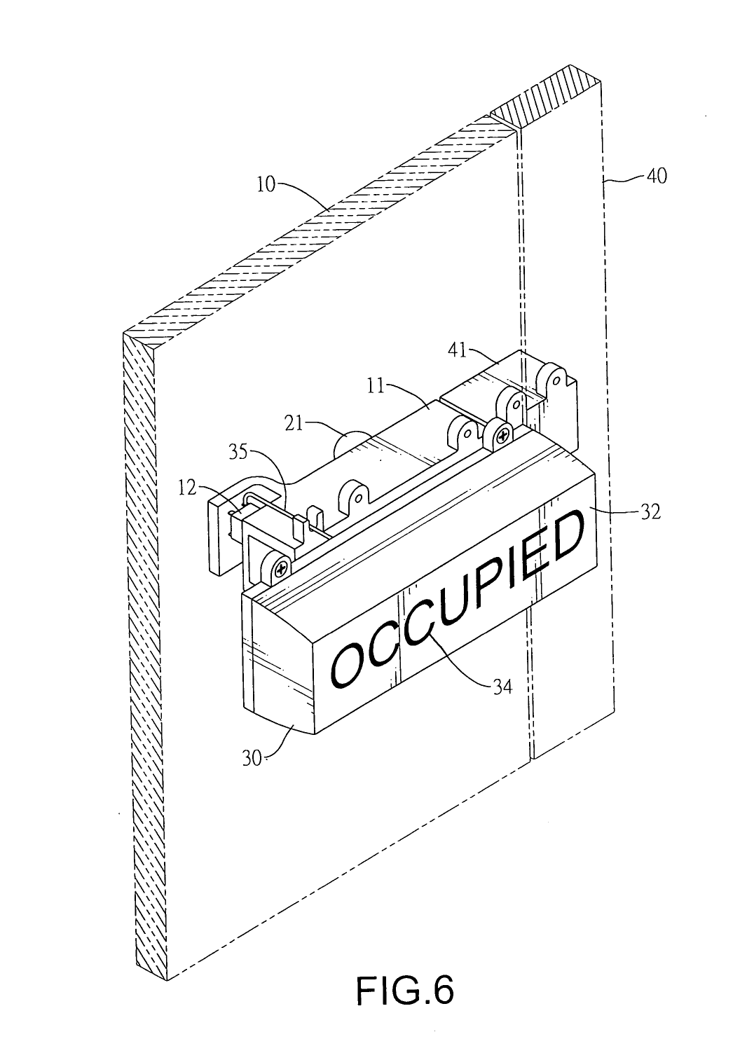

With reference to FIGS. 5, 6,7, 8 and 10, when the latch (20, 20′) extends into the latch seat (41) to lock the door (10), the contact surface (24, 24′) depresses the trigger into the switch (12). The switch (12) activates the illuminating device (33, 33′). The illuminating device (33, 33′) emits light to brighten the message (34, 34′) of the message panel (32) to let people know that the public toilet stall is locked.

When the door (10) is unlocked, the trigger of the switch (12) will extend into the longitudinal recess (22) again and the illuminating device (33, 33′) will be turned off. Accordingly, people are able to know that the public toilet stall is unlocked and free to use.

In conclusion, the emitting message panel (32) lets people know that the public toilet stall is locked. So people will not need to push the door (10) determine whether or not the stall is locked. Consequently, the door (10) is less likely to be damaged and will provide effective privacy longer.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A lock with a status indicator comprises
a seat being hollow, adapted to be mounted on an inside surface of a door and having
an inner end;
an outer end;
an inner opening formed in the inner end;
an outer side;
an inner side; and
a guide slot formed longitudinally through the outer side of the seat between the inner and outer ends;
a latch mounted slidably inside the seat and having;
an inner end;
an outer surface;
an inner surface;
a longitudinal recess formed in the outer surface of the latch;
a contact surface formed near the distal end of the latch; and
a handle having
a proximal end attached to the outer surface of the latch in the longitudinal recess in the outer surface of the latch;
a distal end extending out of the guide slot in the seat;
a switch mounted on the seat, activated by the latch and having
a trigger extending into the longitudinal recess of the latch and depressed selectively by the inclined surface and the contact surface; and
an indicator connected to the switch in the seat, adapted to be mounted on an outside surface of a door and having
an outside surface;
at least one battery mounted in the indicator;
a message panel mounted on the outside surface of the indicator and having
a message on the message panel;
an illuminating device mounted on the message panel; and
multiple electrical leads connected to the switch, the at least one battery and the illuminating device to control the illuminating device.

2. The lock with a status indicator as claimed in claim 1, wherein
the seat further has an activation hole formed through the outer side near the inner end of the seat;
the switch is mounted on the outer surface of the seat near the inner end of the seat; and
the trigger extends through the activation hole in the seat into the longitudinal recess in the outer surface of the latch.

3. The lock with a status indicator as claimed in claim 1, wherein
the seat further has a mounting hole formed through the inner side between the inner and outer ends; and
the switch is mounted in the mounting hole in the inner surface of the seat; and
the trigger extends into the longitudinal recess in the inner surface of the latch.

4. The lock with a status indicator as claimed in claim 2, wherein the lock further has a latch seat, the latch seat is hollow and adapted to be mounted on a doorframe jamb, aligns with the seat and has an inner opening corresponded to the outer opening in the seat;
the latch further has an outer end selectively extending into the latch seat through the outer opening in the latch seat.

5. The lock with a status indicator as claimed in claim 3, wherein the lock further has a latch seat, the latch seat is hollow and adapted to be mounted on a doorframe jamb, aligns with the seat and has an inner opening corresponded to the outer opening in the seat;
the latch further has an outer end selectively extending into the latch seat through the outer opening in the latch seat.

6. The lock with a status indicator as claimed in claim 2, wherein the message is a word.

7. The lock with a status indicator as claimed in claim 2, wherein the message is a figure.

8. The lock with a status indicator as claimed in claim 3, wherein the message is a word.

9. The lock with a status indicator as claimed in claim 3, wherein the message is a figure.

10. The lock with a status indicator as claimed in claim 2, wherein the trigger is a pin.

11. The lock with a status indicator as claimed in claim 3, wherein the trigger is a pin.

12. The lock with a status indicator as claimed in claim 2, wherein the illuminating device is a luminescent card.

13. The lock with a status indicator as claimed in claim 3, wherein the illuminating device is a luminescent card.

14. The lock with a status indicator as claimed in claim 2, wherein the illuminating device is multiple light-emitting diodes.

15. The lock with a status indicator as claimed in claim 3, wherein the illuminating device is multiple light-emitting diodes.

16. The lock with a status indicator as claimed in claim 2, wherein the latch further has an inclined surface formed between the longitudinal recess and the contact surface of the latch.

17. The lock with a status indicator as claimed in claim 3, wherein the latch further has an inclined surface formed between the longitudinal recess and the contact surface of the latch.
